(19) United States
(12) Patent Application Publication
(10) Pub. No.: US 2007/0083792 A1
(43) Pub. Date: Apr. 12, 2007

(54) System and method for error detection and reporting

(76) Inventors: Andrew McDermott, Swindon (GB); Maarten Koning, Bloomfield (CA); Mark Dapoz, Kanata (CA)

Correspondence Address: FAY KAPLUN & MARCIN, LLP, 15O BROADWAY, SUITE 702, NEW YORK, NY, 10038, US

(21) Appl. No.: 11/247,900

(22) Filed: Oct. 11, 2005

(51) Int. Cl. G06F 11/00

(52) U.S. Cl. 714/20

(57) ABSTRACT

Described is a system which includes an error handler to generate an error record in response to a software error in an embedded device and a non-volatile memory including a persistent memory region configured to store an error log, the error log configured to receive the error record, wherein the error log remains intact in the non-volatile memory after a reboot of the embedded device.

### BACKGRONND INFORMATION

It is fairly common for embedded devices to suffer periodically from software or hardware failures. Some of these failures are so profound that they are known as “fatal failures” and may require the embedded device to reboot in order for it to continue to operate properly. This is especially problematic for developers of embedded devices where the developers lack substantial access to system records. Embedded developers have great interest in these failures because their analysis may yield an identification and subsequent correction of the software faults that are responsible for these shortcomings.

Presently, any fatal errors are typically logged to a system console (e.g., displayed on a monitor) with minimal information. Immediately after the error is logged, the target device is rebooted. Once the target has rebooted this information is irretrievably lost. Thus, there is a need for a system for capturing, recording and diagnosing fatal error conditions present in the system.

### SUMMARY OF THE INVENTION

An error detection and recording system which includes an error handler to generate an error record in response to a software error in an embedded device and a non-volatile memory including a persistent memory region configured to store an error log, the error log configured to receive the error record, wherein the error log remains intact in the non-volatile memory after a reboot of the embedded device.

In addition, a method including creating an error log within a persistent memory region allocated within a non-volatile memory, receiving an error record generated in response to a software error in an embedded device and storing the error record in the error log, wherein the error log is configured to remain intact in the non-volatile memory after a reboot of the embedded device.

Furthermore, an embedded device including a memory storing a set of instructions and a processor to execute the set of instructions, wherein the set of instructions are operable to create an error log within a persistent memory region allocated within a non-volatile memory, receive an error record generated in response to a software error in the embedded device and store the error record in the error log, wherein the error log is configured to remain intact in the non- volatile memory after a reboot of the embedded device.

### BRIEF DESCRIPTION OF DRAWINGS

FIG. 1 shows an exemplary embodiment of an embedded device.

FIG. 2 shows a diagram illustrating an exemplary error detection and reporting (“EDR”) log according to the present invention.

FIG. 3 shows an exemplary memory layout of a non-volatile memory including the EDR log according to the present invention.

FIG. 4 shows an exemplary memory layout for a persistent memory region including the EDR log according to the present invention.

FIG. 5 shows an exemplary embodiment of an EDR framework according to the present invention.

FIG. 6 shows an exemplary method for the EDR framework to detect, report and record errors according to the present invention.

### DETAILED DESCRIPTION

The present invention may be further understood with reference to the following description and the appended drawings, wherein like elements are provided with the same reference numerals. Throughout the application the terms target device, embedded device and/or computing device will be used to describe any device which includes a processor or controller capable of executing software instructions to provide a device functionality. Such devices are commonly referred to as embedded devices which typically connotates that the computing device has less available resources than a general purpose computer (e.g., a desktop computer, server, etc.). The reasons for including less resources are varied. For example, the embedded device may only be used for limited functionality (e.g., a home automation device such as a programmable thermostat) and therefore, the device does not need to include all the resources and computing power of a general purpose computer. In another example, the embedded device may be designed as a portable device (e.g., mobile phone, personal digital. assistant (PDA), etc.) which includes limited resources because the device needs to be portable and to use as little power as possible to preserve battery life. Those of skill in the art will understand that there are numerous types of embedded devices and that the present invention is directed to error detection and reporting for these types of devices.

FIG. 1 shows an exemplary embodiment of an embedded device 1 which includes memory 30, a processor 36 and a hard disk 40. The memory 30 may comprise volatile memory 32 (e.g., RAM) and non-volatile memory 34 (e.g., boot ROM, flash memory, etc.). The software 38 such as an operating system and other user applications/processes may be stored on the hard disk 40 or other memory 30. Those of skill in the art will understand that the embedded device 1 is only exemplary and that embedded devices which implement the present invention may include more or less components than described for the exemplary embedded device 1.

The exemplary embodiment of the present invention allows users and developers of the embedded device 1 to record and report errors caused by the software 38 or hardware by storing error records in persistent memory (“PM”) region using the exemplary error detection and reporting (“EDR”) framework 100 as shown in FIG. 5 and discussed in further detail below. The PM region is a segment of non-volatile memory 34 that is explicitly designated not to be erased during a reboot operation of the embedded device 1.

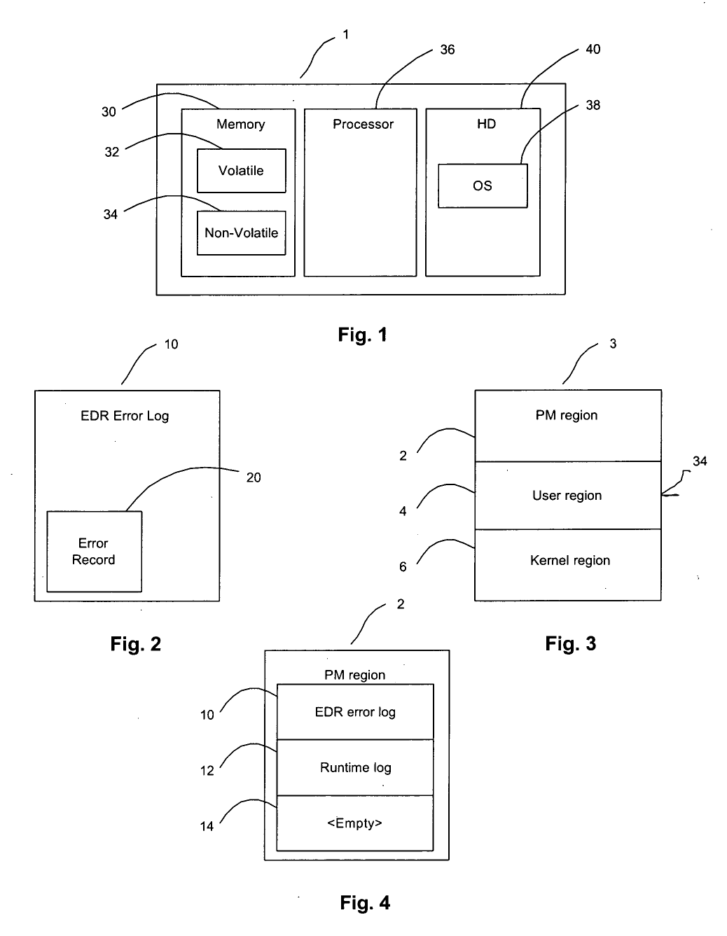

The exemplary embodiment of the present invention identifies software errors then injects the errors into an error record. Each of the error records collected by the EDR framework 100 is then stored in an error log. FIG. 2 shows an exemplary embodiment of an EDR error log 10 which includes an error record 20. In an exemplary embodiment, the EDR error log 10 may act as a ring buffer for a set of error records 20. The minimum and maximum size of one node may be fixed at compile time using a set constant. The error records 20 may be allocated from the beginning of the EDR error log 10 until the log is full. When the EDR error log 10 is full, the EDR error log 10 may “wrap” to allocate new error records 20 back at the beginning.

The EDR error log 10 is persistent since it is stored within the PM region, i.e., the EDR error log 10 is not deleted or modified even when the embedded device 1 is rebooted,. The persistency of the EDR error log 10 is achieved by storing the EDR error log 10 in the PM region which itself is allocated within the non-volatile memory 34. In addition, by storing the EDR error log 10 in the non-volatile memory 34 and not on a hard disk 40 or another type of disk storage device allows the EDR framework 100 to avoid relying on a file system that supports and manages all the files on the hard disk 40. Without the present invention, when a failure occurs, the embedded device 1 may be able to make an error record, but it cannot generate a file on the hard disk 40 because embedded device 1 loses its ability to access and manage the file system. According to the exemplary embodiment of the present invention, the embedded device 1 is able to save and maintain a record of the error by using the EDR framework 100 and non-volatile memory 34 as discussed in further detail below.

The EDR error log 10 contains error record 20 which stores information related to the fault or exception caused by the execution of the software 38. The fault information may include generic information, such as the date and time the exception occurred, the processor type, the processor number, the type and severity of the error, the task ID, the source file and line number and the text payload. In addition, the error record 20 may also include architecture specific information such as the general purpose registers of the processor, an instruction set disassembly surrounding the faulting address, and a symbolic stack trace listing the details of the last set of functions that were called. The above described information stored in the error record 20 is illustrative and developers may modify the data collected during exceptions by using hook mechanisms (e.g., event listeners) to include additional information. Thus, developers may customize the information included in the error record 20 and the “look and feel” of the error record 20 to best suit their needs. In addition, EDR framework 100 is not limited to any specific type of error/exception handler. Therefore, the error records 20 may be customized to include information generated by any type of error/exception handler.

As described above, the error record 20 is located within the EDR error log 10 which is stored in the PM region. The PM region is one of plurality of memory regions that may be located in the non-volatile memory 34. FIG. 3 shows an exemplary memory layout 3 of a non-volatile memory 34. The memory layout 3 may include any number of memory regions reserved for specific software functions, such as PM region 2, a user region 4, and a kernel region 6. The kernel region 6 may comprise low memory addresses of the memory layout 3 which point to processes being run by a kernel of the operating system installed on the embedded device 1. The user region 4 may be reserved for other non-kernel software application processes, such as those run by third-party applications being executed by the embedded device 1. The PM region 2 may represent the top of the memory addresses and may be reserved for storing the EDR error log 10 generated by the EDR framework 100 as discussed further below. Those of skill in the art will understand that the memory layout 3 is only exemplary and that there may be additional regions in the memory layout and the described regions may be allocated differently (e.g., the kernel region may be allocated in high memory addresses).

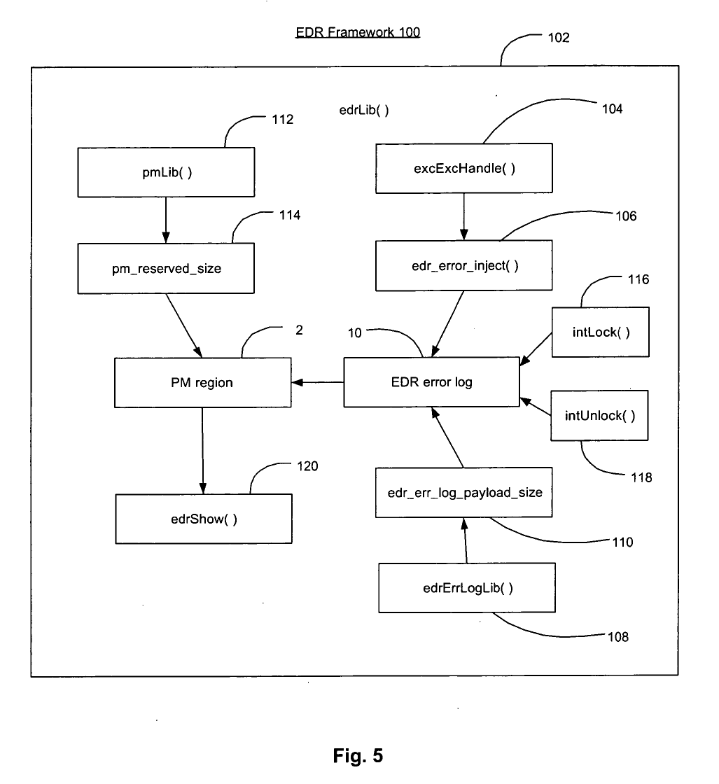

FIG. 4 shows an exemplary memory layout of the PM region 2 on non-volatile memory 34. The PM region 2 may include segments allocated for different parts of the operating system and/or applications included on the embedded device 1. In this example, the PM region 2 includes the EDR error log 10, a runtime log 12, and an empty region 14 that has not been reserved for any storage. The PM region 2 may store data (e.g., logs) that users or developers of the embedded device 1 require or desire to be persistent, i.e., maintained after a reboot. An exemplary runtime log 12 is generated by the WindView® product distributed by Wind River Systems, Inc. of Alameda, Calif. The WindView® product is a runtime analysis tool for software developers who need to inspect the dynamic behavior of embedded systems to detect runtime problems and to improve system performance. These types of logs may be stored in the runtime log segment 12 of the PM region 2.

However, most importantly for the exemplary embodiment of the present invention, the EDR error log 10 may also be stored as a segment of the PM region 2. The PM region 2 may be marked as read-only when the EDR error log 10 is not being updated with new error records. This helps to guarantee the integrity of the data should a software process inadvertently attempt to overwrite the EDR error log 10. This assures that the PM region 2 is only be accessed when new errors are generated, thus keeping the existing error records 20 stored therein intact.

FIG. 5 shows an exemplary embodiment of the EDR framework 100 using a library edrLib( ) 102 to implement the exemplary embodiment of the present invention. Those of skill in the art will understand that there a numerous manners of implementing the present invention and that this exemplary embodiment is only used to illustrate the preferred manner of implementing the present invention. The described functionality for the libraries, macros, functions and constants of the exemplary embodiment may be used to implement other embodiments of the present invention. The edrLib( ) 102 library provides an API for creating the error record 20 containing data on software exceptions, storing the error record 20 in the EDR error log 10, creating the EDR error log 10 if it is not implemented in the PM region 2, and/or reusing the existing EDR error log 10.

The edrLib( ) 102 detects errors by using architecture specific handlers for hardware and software exceptions. In this example, all software exceptions are routed through a function excExcHandle( ) 104 which detects and records various errors and routes the error record 20 by calling a macro edr_error_inject( ) 106. The macro edr_error_inject( )106 injects the error record 20 generated by the function excExcHandle( ) 104 into the EDR error log 10. However, prior to injection, the edr_error_inject( ) 106 initially verifies if the EDR framework 100 is enabled in the embedded device 1 prior to injecting the error record 20. If the EDR framework 100 is not enabled, the macro has no effect. Those of skill in the art will understand that any error/exception handlers may be used with the present invention including both commercially available handlers and proprietary handlers written by developer/users of the embedded device 1. Thus, any error/exception handler may be instrumented to call a macro having the functionality of the described edr_error_inject( ) 106 macro in order to inject the detected errors into an error log.

A library pmLib( ) 112 allocates space for the EDR error log 10 by reserving space from PM region 2 or reusing an existing error log. The amount of reserved space is configurable by the user or developer of the embedded device 1, preferably that amount is about 25% of the total size of the PM region 2. The library pmLib( ) 112 also provides a mechanism for clearing the space allocated for the EDR error log 10 in its entirety if the developer desires to create a new error log.

The contents of the EDR error log 10 are managed by a sub-library edrErrLogLib( ) 108. This library allocates the error record 20 within the EDR error log 10 and sets the minimum and maximum size of one node by a compile time constant edr_err_log_payload_size 110. The sub-library edrErrLogLib( ) 108 sets the minimum size for the EDR error log 10 so that the EDR error log 10 has sufficient space to accommodate the incoming error record 20 from the edr_error_inject( ) 106. If the EDR error log 10 is too small, sub-library edrErrLogLib( ) 108 will reject the edr_error_inject( ) 106 calls. The sub-library edrErrLogLib( ) 108 also manages the internal data structures of the EDR error log 10 by using functions intLock( ) 116 and intUnlock( ) 118 (i.e., to lock and unlock structures), thereby guaranteeing the integrity of the EDR error log 10 in order to allow for allocation of error record 20 generated during an interrupt routine. In addition, the sub-library edrErrLogLib( ) 108 does not utilize any dynamic memory and thus, is safe to call before the operating system's kernel is fully initialized.

The edrLib( ) 102 also includes a function edrShow( ) 120 which is used to view a set of errors collected by the EDR framework 100. The function edrShow( ) 120 extracts the error record 20 from the EDR error log 10 and displays them upon request by the user or developer of embedded device 1. In the alternative, edrShow( ) 120 may also output the contents of the EDR error log 10 in other formats, such as through a printer or as a text file.

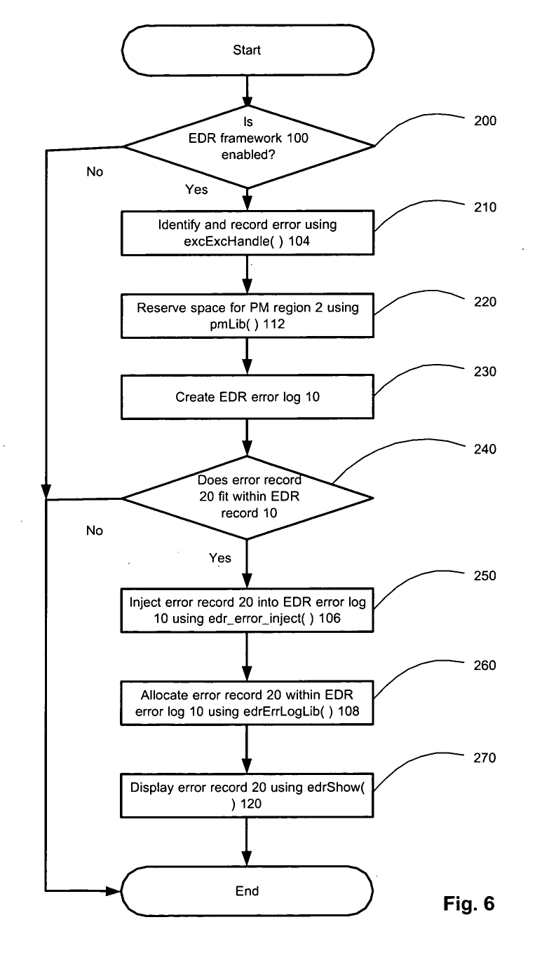

FIG. 6 shows a method for detecting, recording and reporting software errors according to the present invention. In step 200 the edr_error_inject( ) 106 verifies if the EDR framework 100 is enabled. If the EDR framework 100 is not enabled, then no error is recorded and the method is complete. However, a step may be inserted into the method to enable the EDR framework 100 if it has not been previously enabled. If the EDR framework 100 is enabled then the remaining steps in the method are executed. In step 210 the function excExcHandle( ) 104 identifies and records the error. The function also collects the information necessary to compile the error record 20 (e.g., generic and architecture specific) and categorizes those errors. Errors may be categorized into general categories: informational, fatal, and non-fatal. Informational errors simply provide logs about specific processes that had no ill effects on the embedded device 1. Non-fatal errors cause slight interference in the operation of the embedded device 1. Fatal errors are the most severe of software exceptions as they may cause the embedded device 1 to reboot. The developer and/or user may also define other error categories as needed.

The error categorization may be used in conjunction with various system policies that may be in effect. System policies dictate actions that may be undertaken based on the category of the error and what flag is in effect. For example, the system policies may contain a “debug” mode flag or a “lab” mode flag, which are set at boot time by the embedded device 1. When the embedded device 1 is running in “debug” mode and the error was a fatal one, the policy may be set such that the embedded device 1 will not be rebooted. Running the embedded device 1 in this exemplary mode may allow host-based debuger tools to attach to the process that caused the error. This type of mechanism aids the developers by ensuring that the faulting process(es) is still resident within the embedded device 1. Thus, the error record 20, in addition to providing information about the error, may also provide information for the developer to directly analyze the faulting process. Other system policies based on the error categorization may be set within the embedded device 1.

In steps 220 and 230 the EDR error log 10 is created. In step 220, the EDR framework 100 prepares the non-volatile memory 34 to store the error record 20 generated by excExcHandle( ) 104. The library pmLib( ) 112 reserves the space in the non-volatile memory 34 for the PM region 2. In addition, if the developer so desires, the PM region 2 may be cleared of any EDR error log 10 that was previously stored. In step 230, the edrErrLogLib( ) 108 sets the minimum size of the EDR error log 10 in order to ensure that there is enough space to accept and store the error record 20. In an alternative embodiment, steps 220 and 230 may be performed prior to the recording of the error, such as when the operating system is initialized.

In step 240, prior to injecting the error record 20 into the EDR error log 10 sub-library edrErrLogLib( ) 108 will verify that the EDR error log 10 is of sufficient size. If not, then the attempt to inject the error record 20 will be rejected and the method is complete. If the EDR error log 10 is able to accept the error record 20, then the method proceeds to step 250 where the macro edr_error_inject( ) 106 injects the error record 20 into the EDR error log 10.

In step 260, after the error record 20 has been injected it is allocated within the EDR error log 10 by the sub-library edrErrLogLib( ) 108. As stated above, this sub-library is responsible for managing the EDR error log 10. After the error record 20 has been injected and allocated within the EDR error log 10, in step 270, the function edrshow( ) 120 outputs the error record 20 on the desired output device.

As described above, since the error records 20 are stored in persistent memory, a user and/or developer may retrieve the error records after the embedded device 1 reboots, e.g., after the occurrence of a fatal error which causes a reboot. Thus, if the embedded device 1 experiences a fatal error and reboots, the developer may use the edrShow( ) 120 function to output the error record associated with the fatal error. The error record 20 will be maintained in persistent memory and therefore will not be erased or overwritten during the boot process. The saved error record 20 may then be used by the developer to determine the cause of the fatal error. Similarly, other error records 20 for non-fatal errors may also be maintained which the developer may view either before or after the reboot process.

In the above description, the EDR error log 10 was described as being maintained on the non-volatile memory 34 of the embedded device 1. Those of skill in the art will understand that it also may be possible to store the EDR error log 10 in other types of memory provided that this memory is persistent, i.e., the memory is capable of storing the EDR error log 10 after a fatal error occurred (e.g., the memory is not dependent upon a file system that becomes inoperable upon a fatal error) and the memory is not erased or overwritten during the rebooting process. Examples of other memory devices which may store the EDR error log 10 include a pluggable FLASH memory, the memory of a host device, etc.

The following is an exemplary error record 20 that may be generated and output by an exemplary embodiment of the present invention:

ERR0R L0G

| ========= | |
|---|---|
| CPU Number/Type: | 0/0x5a |
| Errors Missed: | 0 (old) + 0 (recent |

==[4/4]============================

| | |
|---|---|
| Severity/Facility: | FATAL/KERNEL |
| Time: | THU JAN 01 00:16:44 1970 |
| | (ticks = 60254) |
| Boot count/cycle: | 2/2 |
| Task: | “t1” (0x001ff078) |
| Source file/line: | excArchLib.c:1902 |
| Text: | “task-level exception!” |

| <<<<Exception Information>>>> | | | |
|---|---|---|---|
| data access | | | |
| Exception current instruction address: 0x00086f2c | | | |
| Machine Status Register: 0x00009032 | | | |
| Data Access Register: 0x00200000 | | | |
| Condition Register: 0x00000000 | | | |
| Data storage interrupt Register: 0x8a000000 | | | |
| <<<<Registers>>>> | | | |
| r0 = 0 | sp = 1fefa8 | r2 = 0 | r3 = 200000 |
| r4 = 0 | r5 = 0 | r6 = 0 | r7 = 0 |
| r8 = 0 | r9 = 0 | r10 = 0 | r11 = 0 |
| r12 = 86fd4 | r13 = 0 | r14 = 0 | r15 = 0 |
| r16 = 0 | r17 = 0 | r18 = 0 | r19 = 0 |
| r20 = 0 | r21 = 0 | r22 = 0 | r23 = 0 |
| r24 = 0 | r25 = 0 | r26 = 0 | r27 = 0 |
| r28 = 0 | r29 = 1ff050 | r30 = 0 | r31 = 0 |
| msr = 9032 | lr = 86f44 | ctr = 0 | pc = 86f2c |
| cr = 0 | xer = 0 | | |

| <<<<Disassembly>>>>> | | | |
|---|---|---|---|
| 0x86f0c | 83c10018 | lwz | r30,24(r1) |
| 0x86f10 | 83e1001c | lwz | r31,28(r1) |
| 0x86f14 | 38210020 | addi | r1,r1,0x20 # 32 |
| 0x86f18 | 4e800020 | blr | |
| | | edrSystemDebugMode: | |
| 0x86f1c | 3d20000c | lis | r9,0xc # 12 |
| 0x86f20 | 80692d2c | lwz | r3,11564(r9) |
| 0x86f24 | 4e800020 | blr | |
| | | edrFault0: | |
| 0x86f28 | 38000000 | li | r0,0x0 # 0 |
| 0x86f2c | 90030000 | stw | r0,0(r3) |
| 0x86f30 | 4e800020 | blr | |
| | | edrFault1: | |
| 0x86f34 | 9421fff0 | stwu | r1,−16(r1) |
| 0x86f38 | 7c0802a6 | mfspr | r0,LR |
| 0x86f3c | 90010014 | stw | r0,20(r1) |
| 0x86f40 | 4bffffe9 | bl | 0x86f28 # edrFault0 |
| 0x86f44 | 80010014 | lwz | r0,20(r1) |
| 0x86f48 | 7c0803a6 | mtspr | LR,r0 |

| <<<<Stack Trace>>>> | |
|---|---|
| a3808 vxTaskEntry | +64 : edrFault ( ) |
| 86fe4 edrFault | +10 : edrFault5 ( ) |
| 86fc4 edrFault5 | +10 : edrFault4 ( ) |
| 86fa4 edrFault4 | +10 : edrFault3 ( ) |
| 86f84 edrFault3 | +10 : edrFault2 ( ) |
| 86f44 edrFault1 | +10 : edrFault0 ( ) |

value = 0 = 0x0

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

What is claimed is:

1. A system, comprising:
an error handler generating an error record in response to a software error in an embedded device; and
a non-volatile memory including a persistent memory region configured to store an error log, the error log configured to receive the error record, wherein the error log remains intact in the non-volatile memory after a reboot of the embedded device.

2. The system of claim 1, further comprising:
an error injection module receiving the error record from the error handler and injecting the error record into the error log.

3. The system of claim 1, wherein the software error is an operating system error.

4. The system of claim 1, wherein the non-volatile memory is one of a flash memory and a read only memory.

5. The system of claim 1, wherein the non-volatile memory is external to the embedded device.

6. The system of claim 1, wherein the error record includes one of a date of the error, a time of the error, a processor type of the embedded device, a processor number of the embedded device, a type of the error, a severity of the error, a task ID, a source file identification, a line number in a source file, a text payload, a register of a processor of the embedded device, an instruction set disassembly surrounding a faulting address, and a symbolic stack trace listing details of a last set of functions that were called.

7. The system of claim 1, wherein the persistent memory region comprises a top of a set of memory addresses in the non-volatile memory.

8. The system of claim 1, wherein the error log comprises 20%- 30% of the persistent memory region.

9. The system of claim 1, wherein the error record is one of displayed and printed after the reboot of the embedded device.

10. A method, comprising the steps of:
creating an error log within a persistent memory region allocated within a non-volatile memory;
receiving an error record generated in response to a software error in an embedded device; and
storing the error record in the error log, wherein the error log is configured to remain intact in the non-volatile memory after a reboot of the embedded device.

11. The method of claim 10, wherein the error log includes a set of nodes and one of a minimum size and a maximum size of each node is fixed at a compile time of the embedded device.

12. The method of claim 10, wherein the error log is configured to operate as a ring buffer.

13. The method of claim 10, wherein the error record includes one of a date of the error, a time of the error, a processor type of the embedded device, a processor number of the embedded device, a type of the error, a severity of the error, a task ID, a source file identification, a line number in a source file, a text payload, a register of a processor of the embedded device, an instruction set disassembly surrounding a faulting address, and a symbolic stack trace listing details of a last set of functions that were called.

14. The method of claim 10, further comprising the step of:
generating the error record in response to the software error.

15. The method of claim 10, further comprising the step of:
injecting the error record into the error log.

16. The method of claim 10, further comprising the step of:
verifying a size of the error record is smaller than a size of the error log.

17. The method of claim 10, further comprising the step of:
extracting the error record from the error log after the reboot for output.

18. The method of claim 10, further comprising the step of:
providing operational information to the embedded device based on a categorization of the error in the error record.

19. The method of claim 18, wherein the categorization includes one of a fatal category, a non-fatal category and an informational category.

20. An embedded device including a memory storing a set of instructions and a processor to execute the set of instructions, wherein the set of instructions are operable to:
create an error log within a persistent memory region allocated within a non-volatile memory;
receive an error record generated in response to a software error in the embedded device; and
store the error record in the error log, wherein the error log is configured to remain intact in the non-volatile memory after a reboot of the embedded device.
